(19) United States
(12) Patent Application Publication
(10) Pub. No.: US 2026/0342696 A1
(43) Pub. Date: Oct. 29, 2026

(54) MEASUREMENT REPORTING METHOD AND APPARATUS

(71) Applicant: ZTE CORPORATION, Shenzhen, Guangdong (CN)

(72) Inventors: Ling YANG, Shenzhen (CN); Bo GAO, Shenzhen (CN); Zhaohua LU, Shenzhen (CN); Xiaolong GUO, Shenzhen (CN); Ke YAO, Shenzhen (CN)

(21) Appl. No.: 19/471,527

(22) PCT Filed: Apr. 7, 2023
(86) PCT No.: PCT/CN2023/087109

§ 371 Date: Oct. 1, 2025

(51) Int. Cl. H04L 43/065; H04B 7/06; H04B 17/318

(52) U.S. Cl. CPC H04L 43/065; H04B 7/0626; H04B 17/328

(57) ABSTRACT

Methods, apparatus, and systems related to measurement reporting in wireless communication systems are described. In one example aspect, a method for wireless communication includes transmitting, by a wireless device to a network device, a report including information with a specific format. Another method for wireless communication includes receiving, by a network device from a wireless device, a report including information with a specific format and performing an operation based on the received report.

### CROSS-REFERENCE TO RELATED APPLICATION(S)

The present disclosure is a national phase entry under 35 USC 371 of International Patent Application No. PCT/CN2023/087109 filed on Apr. 7, 2023, the entire contents of the International Patent Application is incorporated herein by reference.

### TECHNICAL FIELD

This patent document is related to wireless communication.

### BACKGROUND

Mobile telecommunication technologies are moving the world toward an increasingly connected and networked society. In comparison with the existing wireless networks, next generation systems and communication techniques will need to support a much wider range of use-case characteristics and provide a more complex and sophisticated range of access requirements and flexibilities.

Long-Term Evolution (LTE) is a standard for wireless communication for mobile devices and data terminals developed by 3rd Generation Partnership Project (3GPP). LTE Advanced (LTE-A) is a wireless communication standard that enhances the LTE standard. The 5th generation of wireless system, known as 5G, advances the LTE and LTE-A wireless standards and is committed to supporting higher data-rates, large number of connections, ultra-low latency, high reliability and other emerging business needs.

### SUMMARY

This patent document discloses techniques, among other things, related to measurement reporting methods in a wireless communication network.

In one example aspect, a wireless communication method is disclosed. The method includes transmitting, by a wireless device to a network device, a report including information with a specific format.

In another example aspect, another wireless communication method is disclosed. The method includes receiving, by a network device from a wireless device, a report including information with a specific format; and performing an operation based on the received report.

In yet another example aspect, a wireless communication device comprising a process that is configured or operable to perform the above-described methods is disclosed.

In yet another example aspect, a computer readable storage medium is disclosed. The computer-readable storage medium stores code that, upon execution by a processor, causes the processor to implement an above-described method.

### BRIEF DESCRIPTION OF THE DRAWINGS

FIGS. 1-5 show example diagrams of bitmap design.

FIGS. 6-11 show example diagrams of reference RS per Cell/Cell group design.

FIGS. 12-15 show example diagrams of configuration structures.

FIG. 16 shows an example of is a block diagram of an example of a hardware platform that may be a part of a network device or a communication device, in accordance with some embodiments of the present document.

FIG. 17 shows an example of network communication including a network device (BS) and wireless device based on some implementations of the disclosed technology.

FIGS. 18-19 are flowcharts representation of methods for wireless communication in accordance with one or more embodiments of the present technology.

### DETAILED DESCRIPTION

Section headings are used in the present document to facilitate understanding and do not limit the scope of the disclosed technology to particular sections. Furthermore, certain terminology referring to 5G and Third Generation Partnership Project (3GPP) protocols is used as an illustrative example and the disclosed techniques are applicable to other wireless protocols also.

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale. In should be noted, in the disclosure of this patent application, a network node can be at least one of a Location Management Function (LMF), a Base Station (BS) (e.g., gNB, and/or TRP), or a core network.

### Initial Discussion

In radio access network RAN Plenary #94 e-meeting, a new work item (WI) on Further NR mobility enhancements was approved. The goal of this WI is to enable a serving cell change via L1/L2 signaling with low latency, overhead and interruption time. In order to support cell change, some enhancement on measurement reporting needs to be considered, such as configuration, reporting method, report criterion and so on.

In the disclosure, the cell includes a serving cell and/or candidate cell. In some examples, the serving cell is called as source cell. The candidate cell is called a “neighbour cell”, “target cell”, “candidate target cell”, “target candidate cell”, or “non-serving cell”, or a cell that is different from the serving cell or other names.

In the disclosure, RS can be at least one of the Synchronization Signals and PBCH block (SSB) and Channel state information reference signal (CSI-RS). Wherein, the type of CSI-RS can be at least one CSI-RS for beam management, CSI-RS for CSI acquisition, CSI-RS for mobility, CSI-RS for Tracking, CSI-RS for interference management.

However, under the existing standard, there is no method for measurement report via L1/L2 signalling. In this patent application, methods, and procedures of signalling transmission are provided for measurement reports for L1/L2 mobility enhancement. The proposed methods are beneficial at least for reducing overhead of report and let network know which cell and/or beams for cell switching. To improve or enhance the signalling efficiency (e.g., reduce the latency, overhead and interruption time), the systems and methods discussed herein can include processes, procedures, and/or implementations for signalling.

The example embodiments disclosed herein are directed to solving the issues relating to one or more of the problems presented in the prior art, as well as providing additional features that will become readily apparent by reference to the following detailed description when taken in conjunction with the accompanying drawings. In accordance with various embodiments, example systems, methods, devices and computer program products are disclosed herein. It is understood, however, that these embodiments are presented by way of example and are not limiting, and it will be apparent to those of ordinary skill in the art who read the present document that various modifications to the disclosed embodiments can be made while remaining within the scope of this disclosure.

### Embodiment 1

In the embodiment, we will introduce some methods for measurement configuration for at least one of serving cell and candidate cell. Any combination of the following examples also belong to the scope of this disclosure.

In some examples, a reporting setting is linked to M resource setting(s). Wherein, M is an integer larger than or equal to 0.

In some examples, each resource setting contains S resource set(s) or a list of S resource set(s) or a configuration of a list of S resource set(s). Wherein, S is an integer larger than and/or equal to 0.

In some examples, the list is comprised of reference(s) to resource set(s), or the list is comprised of resource set(s).

In some examples, each resource set contains P resource(s) or a list of P resource(s) or a configuration of a list of P resource(s).

In some examples, M resource setting(s) is configured for or associated with a cell or cell group. Optionally, each resource setting contains Z resource set(s) or a list of Z resource set(s) or a configuration of a list of Z resource set(s). Wherein, Z can be less than or equal to S.

In some examples, M resource setting(s) is configured for or associated with multiple cells or cell groups. Wherein, relationship between resource setting and cell/cell group can be one-to-one, one-to-many, many-to-one, or many-to-many. Optionally, each resource setting contains Z resource set(s) or a list of Z resource set(s) or a configuration of a list of Z resource set(s). Wherein, Z can be less than or equal to S.

In some examples, S resource set(s) is configured for or associated with a cell or cell group; or S resource set(s) is configured for or associated with multiple cells or cell groups. Wherein, relationship between resource set and cell/cell group can be one-to-one, one-to-many, many-to-one, or many-to-many.

In some examples, one or P resource(s) is configured for or associated with a cell or cell group, or multiple cells or multiple cell groups.

In some examples, resource can be at least one of CSI-RS resource, SSB, CSI-RS for Tracking resource, CSI-RS for interference measurement resource, CSI-RS for CSI acquisition resource and CSI-RS for mobility resource.

In some examples, resource set can be at least one of CSI-RS resource set, SSB set, CSI-RS for Tracking resource set, CSI-RS for interference measurement resource set, CSI-RS for CSI acquisition resource set and CSI-RS for mobility resource set.

In some examples, the number of activated/deactivated resource setting is M1. Wherein, M1 is an integer larger than or equal to 1. Optionally, resource setting is activated/deactivated from the configured resource setting.

In some examples, the maximum number of activated/deactivated resource setting is M1max. M1max can be 1, 2, 3, 4, 5, 6, 7, 8, 9, 10, or scaling of any one of the values mentioned above.

In some examples, the number of activated/deactivated resource set is S1. Wherein, S1 is an integer larger than or equal to 1. Optionally, resource set is activated/deactivated from the configured resource set.

In some examples, the maximum number of activated/deactivated resource set is S1max. S1max can be 1, 2, 3, 4, 5, 6, 7, 8, 9, 10, or scaling of any one of the values mentioned above.

In some examples, the number of activated/deactivated resource is P1. Wherein, P1 is an integer larger than or equal to 1. Optionally, resource is activated/deactivated from the configured resource.

In some examples, the maximum number of activated/deactivated resource is P1max. P1max can be 1, 2, 3, 4, 5, 6, 7, 8, 9, 10, or scaling of any one of the values mentioned above.

### Embodiment 2

In the embodiment, we will introduce some methods for configuration (e.g., report and so on) for at least one of serving cell and candidate cell. Any combination of the following examples also belong to the scope of this disclosure.

In some examples, report configuration contains at least one of the following information: time domain resource for report, report type, quantity to be reported by UE, RS resource indicator, report mode, number of RS to be reported, number of cell or cell group to be reported, group-based report.

In some examples, report type can be one of periodicity, aperiodicity and semi-persistent.

In some examples, quantity can be at least one of L1-RSRP, L1-SINR, L1-RSRQ.

In some examples, RS resource indicator can be one of SSBRI and CRI.

In some examples, report mode can be one of CSI-RS based report, event-triggered report and other report method.

In some examples, number of RS to be reported (X) is an integer larger than or equal to 1. Optionally, the maximum number of RS to be reported is Xmax. Xmax can be 1, 2, 3, 4, 5, 6, 7, 8, 9, 10, or scaling of any one of the values mentioned above. Note that RS can be RS resource, RS group, RS resource group, RS resource set, RS resource set group, RS resource setting, RS resource setting group.

In some examples, number of cell or cell group to be reported (W) is an integer larger than or equal to 1. Optionally, the maximum number of cell or cell group to be reported is Wmax. Wmax can be 1, 2, 3, 4, 5, 6, 7, 8, 9, 10, or scaling of any one of the values mentioned above.

In some examples, cell or cell group or RS or RS resource or RS resource set or resource setting, report configuration can be configured cell or cell group or RS or RS resource or RS resource set or resource setting, report configuration; activated/deactivated cell or cell group or RS or RS resource or RS resource set or resource setting, report configuration; or reported cell or cell group or RS or RS resource or RS resource set or resource setting, report configuration.

In some examples, the number of configured cell or cell group is Y. Wherein, Y is an integer larger than or equal to 1.

In some examples, the maximum number of configured cell or cell group is Ymax. Ymax can be 1, 2, 3, 4, 5, 6, 7, 8, 9, 10, or scaling of any one of the values mentioned above.

In some examples, the number of activated/deactivated cell or cell group is Z. Wherein, Z is an integer larger than or equal to 1. Optionally, cell or cell group is activated/deactivated from the configured cell or cell group.

In some examples, the maximum number of activated/deactivated cell or cell group is Zmax. Zmax can be 1, 2, 3, 4, 5, 6, 7, 8, 9, 10, or scaling of any one of the values mentioned above.

### Embodiment 3

In the embodiment, we will introduce some methods for the measurement report.

If the UE is configured with a report configuration with report quantity, the UE shall report measurement reporting with a specific report format.

In some examples, X report information is included in a report instance. Wherein, report information include at least one of RS resource indicator (RSRI), cell identification, quality corresponding to RS, and report mode.

In some examples, X RSRI is included in a report instance.

In some examples, X RSRI and X measurement quality corresponding to RSRI are included in a report instance.

In some examples, X RSRI and X measurement quality corresponding to RSRI and cell index/identification are included in a report instance.

In some examples, X RSRI and X measurement quality corresponding to RSRI and cell index/identification and report mode are included in a report instance.

In some examples, X RSRI and X measurement quality corresponding to RSRI and report mode are included in a report instance.

For any one of example mentioned above, X RSRI is from or associated with or configured from the same cell or cell group; or X RSRI is from or associated with or configured from different cell groups. Optionally, relationship between RSRI and cell or cell group can be one-to-one, one-to-many, many-to-one, many-to-many. Optionally, relationship between RSRI and resource or resource set or resource setting from same cell or cell group can be one-to-one, one-to-many, many-to-one, many-to-many. Optionally, relationship between RSRI and resource or resource set or resource setting from difference cell or cell group can be one-to-one, one-to-many, many-to-one, many-to-many.

In some examples, for different cell or cell group, the number of reported RS can be same or different or fix or configurable or depend on UE capability.

In some examples, RS can be at least one of SSB and CSI-RS.

In some examples, quality can be one of Reference Signal Received Power (RSRP), Reference Signal Received Quality (RSRQ), Signal to Interference plus Noise Ratio (SINR). Optionally, RSRP, RSRQ, SINR can be L1-RSRP, L1-RSRQ, L1-SINR, L1-RSSI, L3-RSRP, L3-RSRQ, L3-SINR, L3-RSSI.

In some examples, report mode includes at least CSI based report, event-triggered reports, other report methods and so on.

In some examples, at least one of the following methods can be considered for report:
Alt-1: X beam(s) or RS resource indicator(s) reported in a report instance;
Alt-2: Y Cell(s) or Cell group(s), and X beam(s) or RS resource indicator(s) reported in a report instance.

In some examples, for Alt-1, cell information is not included in a report instance, network can identify cell/cell group information corresponding to reported RSRI through the reported RS indicator. Wherein, relationship between RS resource or RS resource indicator and cell or cell group is defined or configured by at least one of RRC, MAC CE, DCI and pre-defined. Optionally, relationship between RS resource or RS resource indicator and cell or cell group can be at least one of one-to-one, one-to-many, many-to-one, many-to-many.

In some examples, for Alt-1, X beam(s) or RS resource indicator(s) consist of the best or strongest one or P beam(s) or RS resource indicator(s) for each cell or cell group or each activated cell/cell group or each determined cell/cell group. Wherein, determined cell/cell group can be best or strongest one or multiple cell or cell group for all cell/cell group or all activated cell/cell group or all configured cell/cell group. Wherein, P is an integer larger than and/or equal to 1. Optionally, the number of beam or RS resource indicator that can be reported by each cell or cell group can be the same or different, fixed or configured.

In some examples, for Alt-1, X beam(s) or RS resource indicator(s) consist of the best or strongest X beam(s) or RS resource indicator(s) for all cell/cell group or all activated cell/cell group or all determined cell/cell group. Wherein, determined cell/cell group can be best or strongest one or multiple cell or cell group for all cell/cell group or all activated cell/cell group or all configured cell/cell group.

In some examples, for Alt-1, if group-based report is configured or indicated, X or P beam(s) or RS resource indicator(s) is regarded as a group for each cell or cell group to be reported. Optionally, relationship between beam-based group and cell or cell group is defined or configured by at least one of RRC, MAC CE, DCI and pre-defined. Optionally, relationship between group and cell or cell group can be at least one of one-to-one, one-to-many, many-to-one, many-to-many. Optionally, beam-based group can be applied for all cell or cell group in a frequency, or across different frequency.

In some examples, X beam(s) or RS resource indicator(s) is from or associated with or configured from the same cell or cell group; or X beam(s) or RS resource indicator(s) is from or associated with or configured from different cell groups. Optionally, relationship between beam(s) or RS resource indicator(s) and cell or cell group can be one-to-one, one-to-many, many-to-one, many-to-many. Optionally, relationship between beam(s) or RS resource indicator(s) and resource or resource set or resource setting from same cell or cell group can be one-to-one, one-to-many, many-to-one, many-to-many. Optionally, relationship between beam(s) or RS resource indicator(s) and resource or resource set or resource setting from difference cell or cell group can be one-to-one, one-to-many, many-to-one, many-to-many.

In some examples, X beam(s) or RS resource indicator(s) can be from at least one of the configured cell(s), or the activated/updated/selected cell(s), or, all configured cell(s), or, all activated/updated/selected cell(s), or, associated cell(s), or associated configured cell(s), or associated activated/updated/selected cell(s).

In some examples, X beam(s) or RS resource indicator(s) can be from at least one of the configured cell(s), the activated/updated/selected cell(s), or all configured cell(s), or, all activated/updated/selected cell(s), or, associated cell(s), or associated configured cell(s), or associated activated/updated/selected cell(s) in one frequency.

In some examples, X beam(s) or RS resource indicator(s) can be from at least one of the configured cell(s), the activated/updated/selected cell(s), or all configured cell(s), or, all activated/updated/selected cell(s), or, associated cell(s), or associated configured cell(s), or associated activated/updated/selected cell(s) across different frequencies.

In some examples, any one or more methods on X beam(s) or RS resource indicator(s) reported in a report instance mentioned in Alt-1 can used for Alt-2.

In some examples, for Alt-2, Y cell(s) or cell group(s) is the best or strongest Y cell(s) or cell group(s) for all cell or cell group or all activated cell/cell group.

In some examples, for Alt-2, X beam(s) or RS resource indicator(s) consist of the best or strongest one or P beam(s) or RS resource indicator(s) for each of Y cell(s) or cell group(s) or each of Y activated cell(s) or cell group(s). Wherein, P is an integer larger than and/or equal to 1. Optionally, the number of beam or RS resource indicator that can be reported by each cell or cell group can be the same or different, fixed or configured.

In some examples, for Alt-2, X beam(s) or RS resource indicator(s) is the best or strongest X beam(s) or RS resource indicator(s) for each of Y cell(s) or cell group(s) or each of Y activated cell(s) or cell group(s). For this case, the number of beam(s) or RS resource indicator(s) to be reported in a report instance is X*Y.

In some examples, for Alt-2, X beam(s) or RS resource indicator(s) consist of the best or strongest X beam(s) or RS resource indicator(s) for all Y cell/cell group or all Y activated cell/cell group.

In some examples, for Alt-2, if group-based report is configured or indicated, X or P beam(s) or RS resource indicator(s) is regarded as a group for each of Y cell(s) or cell group(s) or each of Y activated cell(s) or cell group(s). Optionally, relationship between beam based group and cell or cell group is defined or configured by at least one of RRC, MAC CE, DCI and pre-defined. Optionally, relationship between beam based group and cell or cell group can be at least one of one-to-one, one-to-many, many-to-one, many-to-many. Optionally, beam-based group can be applied for all cell or cell group in a frequency, or across different frequency.

In some examples, X beam(s) or RS resource indicator(s) is from or associated with or configured from the same cell or cell group; or X beam(s) or RS resource indicator(s) is from or associated with or configured from different cell groups. Optionally, relationship between beam(s) or RS resource indicator(s) and cell or cell group can be one-to-one, one-to-many, many-to-one, many-to-many. Optionally, relationship between beam(s) or RS resource indicator(s) and resource or resource set or resource setting from same cell or cell group can be one-to-one, one-to-many, many-to-one, many-to-many. Optionally, relationship between beam(s) or RS resource indicator(s) and resource or resource set or resource setting from difference cell or cell group can be one-to-one, one-to-many, many-to-one, many-to-many.

For method mentioned above, relationship can be configured by at least one of RRC, MAC CE, DCI and pre-defined.

In some examples, for Alt-2, the issue on how to determine/select beam(s)(or beam group) and/or Cell(s)(or Cell group) information can consider at least one of the following methods:
Alt-1: Bitmap method;
Alt-2: Introduce the “Cell identification” field.

The following embodiment will further introduce the above alternatives mentioned.

### Embodiment 4

In the embodiment, we will introduce a method of bitmap to determine beam(s)(or beam group) and/or Cell(s)(or Cell group) to be reported.

A bitmap indicates which of Y Cell(s)/Cell groups to be selected or which Cell/Cell group of Y Cell(s)/Cell groups to be included in a report instance.

In some examples, each bit in the bitmap corresponds to or is associated with Cell or cell group identification. Wherein, Cell is indexed in the order of increasing or decreasing or random. A cell group is indexed in the order of increasing or decreasing, or random. Cell in a Cell group is indexed in the order of increasing or decreasing or random. Optionally, the order of bitmap is such that Cell #1 to Cell #Y are mapped from the bitmap's MSB(LSB) to LSB(MSB). A cell is selected if the corresponding bit value in the bitmap is 1. A cell is not selected if the corresponding bit value in the bitmap is 0.

In some examples, the size of the bitmap can be fixed or configurable. Optionally, the size of a fixed bitmap or the size of a configurable bitmap is configured/determined by at least one of RRC, MAC CE, DCI, default, per-defined, the number of cells, the number of configured cells, or the number of selected/updated/activated cell.

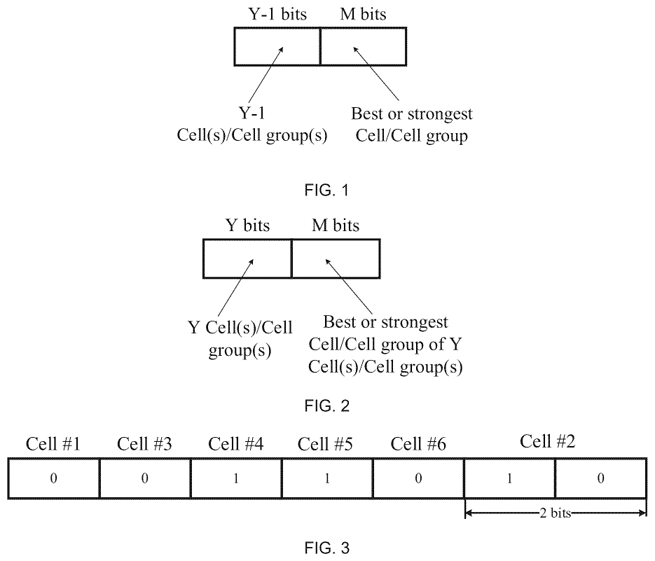

At least one of the following method can be used to determine or indicate which Cell/Cell group to be included in a report instance or cell information corresponding to reported beam(s).
Alt-1.1: Y-1 bits+M bits as shown in FIG. 1, or M bits+Y-1 bits.

Wherein, Y-1 bits are used to indicate/determine which Y-1 Cell(s)/Cell groups to be selected or determined or which Cell/Cell group of Y-1 Cell(s)/Cell groups have corresponding information to be included in a report instance. In some examples, it is assumed that the number of Cell/Cell group is Y, which is labelled as Cell #1, Cell #2, . . . , Cell #Y, or Cell #0, Cell #1, . . . , Cell #Y-1, or Cell ID is marked as a value, e.g., Cell #2, Cell #4, Cell #6, Cell #7, . . . , Cell #Y are sequentially labelled as 1, 2, 3, . . . , Y.

Wherein M is the number of bits used to indicate the best or strongest Cell/Cell group. M bits are determined by at least one of the following methods:
Method-1: M=log2(ceil(Cell index));
Method-2: M=log2(ceil(the number of Cell));

Note that other methods to determine/select/indicate the best or strongest Cell/Cell group also belong to the scope of this disclosure to protect.
Alt-1.2: Y bits+M bits as shown in FIG. 2, or M bits+Y bits.

Different from Alt-1.1, Y bits in Alt-1.2 is used to indicate/determine which of Y Cell(s)/Cell groups to be selected or determined or which Cell/Cell group of Y Cell(s)/Cell groups have corresponding information to be included in a report instance.

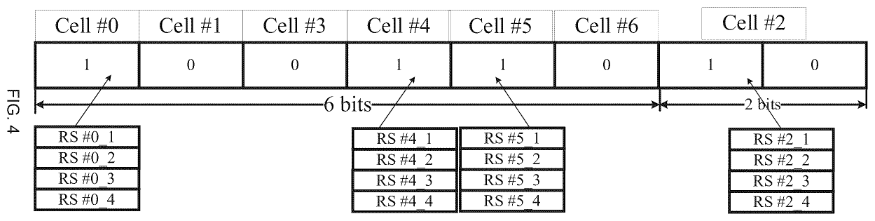

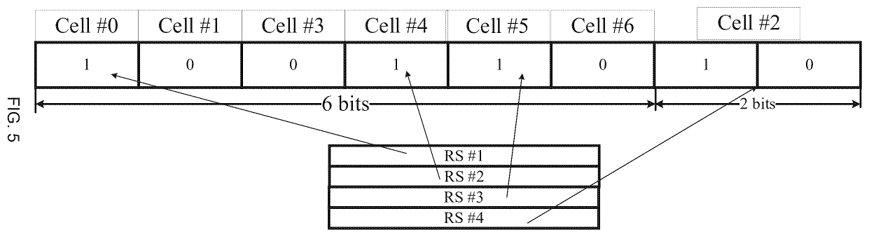

Taking an example to illustrate the bitmap method to indicate Cell/Cell group and/or RS(s). Assumed that the number of Cell is 7, such as Cell #0, Cell #1, . . . , Cell #6. Optionally, the corresponding PCI is Cell # P, Cell # Q, Cell # T, Cell # S, Cell # J, Cell # K, and Cell # L. Wherein 10011010 represents Cell #0, Cell #2, Cell #4, and Cell #5 to be reported, where last 2 bits (10) indicate Cell #2 is the best or strongest Cell, as shown in FIG. 3. P beams or RSs per Cell is reported, such as P is equal to 4 as shown in FIG. 4. That is to say, 16 beams or RSs (X) is included in a report instance, wherein, each cell corresponds to 4 beams or RSs. Optionally, X beams is reported such as X is equal to 4 and are associated with different cell, as shown in FIG. 5. That is to say, 4 beams or RSs (X) is included in a report instance, wherein, reported beam #1 or RS #1 is from Cell #0, beam #2 or RS #2 is from Cell #4, beam #3 or RS #3 is from Cell #5, beam #4 or RS #4 is from Cell #2, and best cell is cell #0 and best beam or RS is beam #4 or RS #4. Each cell only reports one beams or RSs.

Notes that any one of above mentioned rule for RS or beam is also applied for quality parameter.

### Embodiment 5

In the embodiment, we will introduce a method to determine beam(s)(or beam group) and/or Cell(s)(or Cell group) by introducing a Cell or cell group identification field.

For this method, a cell or cell group identification or index field is used to indicate a cell information corresponding to reported information or best or strongest cell or cell group.

Option-1: P information is reported for each Cell/Cell group;

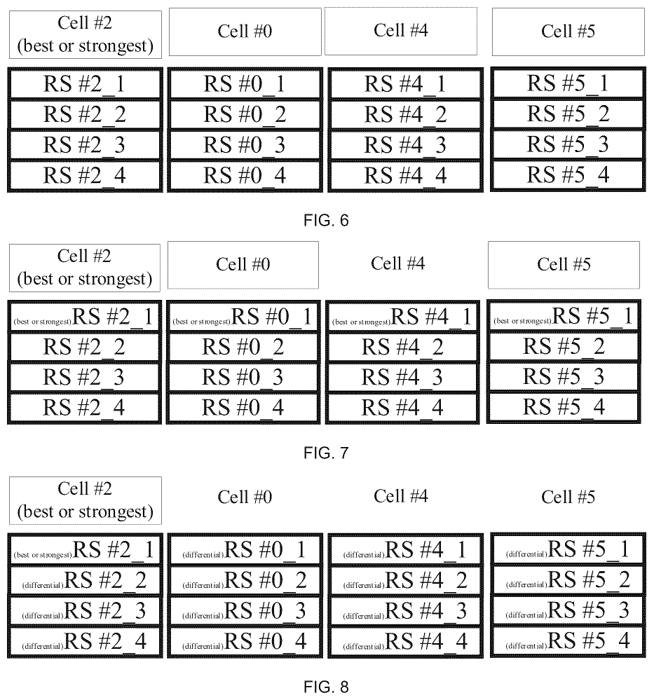

As shown in FIG. 6 to FIGS. 8, 4 cell or cell group is reported or indicated and 4 information is reported for each cell or cell group, wherein, reported information can be RSRI and corresponding quality. Metrics or quality can be RSRP, RSRQ, RSSI or SINR. In FIG. 6, best cell or cell group or best or strongest RS and/or quality can be placed at the forefront.

In some examples, for each cell or cell group, P reported information consist of best or strongest information and differential information. Wherein, the differential information is determined with a reference to the best or strongest information. As shown in FIGS. 7, 4 report information (e.g., RSRI and corresponding quality) is reported for each cell. The best or strongest of the 4 reported information is placed first, and the remaining information is differential relative to the strongest information.

In some example, for all cell or cell group, X reported information consist of best or strongest information for best or strongest cell or cell group and the differential information for cell or cell group. Wherein, the differential information is determined with a reference to the best or strongest information for best or strongest cell or cell group among all cell or cell group. As shown in FIGS. 8, 4 report information (e.g., RSRI and corresponding quality) is reported for each cell. The best or strongest of the 16 reported information is placed first, and the remaining information is differential relative to the strongest information.

Option-2: group based report per Cell/Cell group;

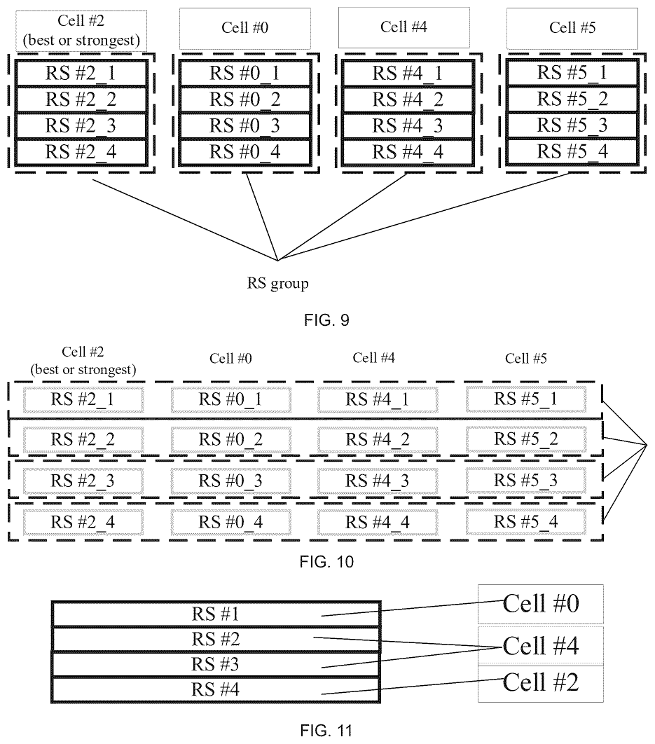

In some examples, X group is included in a report instance. Each group include P report information. Each group corresponds to a cell or cell group. As shown in FIGS. 9, 4 group are reported and each group corresponds to a cell or cell group. Each group contains 4 report information.

In some examples, X group is included in a report instance. Each group include W report information for different cells. As shown in FIGS. 10, 4 group are reported and each group contains report information of 4 cell or cell group.

In some examples, the best or strongest of the X group is placed first. Optionally, the remaining group is differential relative to the strongest group. Optionally, the reporting information for the other group is differential relative to report information within strongest group. Optionally, for the best or strongest group, the best or strongest report information is placed first, other report information is differential relative to the strongest report information.

In some examples, for each group, best or strongest report information is placed first. Other report information is differential relative to the strongest report information.

In some examples, the best or strongest of the X group is placed first. Wherein, the best or strongest group contain best or strongest report information of each cell or cell group. The remaining group or report information is differential relative to the strongest group or information included in the strongest group.

In some examples, the best or strongest of the X group is placed first. Wherein, the best or strongest group contain different cell. In best or strongest group, best or strongest report information is placed first, the remaining report formation is differential relative to the strongest group or information. For other group, report information is differential relative to the strongest report information within best or strongest group.

In some examples, group-based report can be also applied for one frequency or across different frequencies case.

RS group is associated with the same or different Cell/Cell group. Different RS groups are associated with different Cell/Cell groups.

In some examples, reference RS in the RS group can be the best or strongest RS or metric corresponding to the best or strongest RS. Wherein metrics can be RSRP, RSRQ or SINR.

Option-3: reported information is for one or multiple cell or cell group.

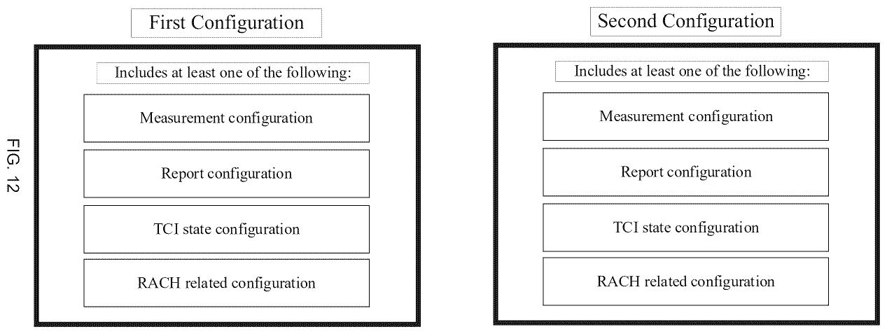

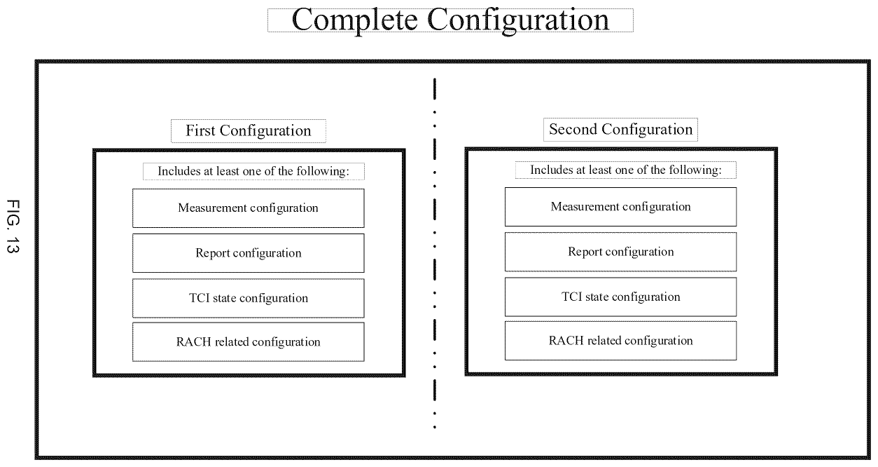

In some examples, reported information is associated with Cell/Cell group. Reported information in a report instance can be associated with the same Cell/Cell group or a different Cell/Cell group, as shown in FIG. 11.

Any one or more method mentioned in the disclosure can be regarded as a general design. The above embodiments are only examples to explain the scheme, but are not limited to the implementation scenario.

Note that whether measurement result from serving cell is included in a report instance, at least one of the following method can be considered:

Alt-1 (default): measurement result from serving cell is always included in a report instance.

Alt-2 (configurable): introduce a field to indicate “with or without” measurement result from serving cell in a report instance;

If this field is present, then measurement result from serving cell is included in a report instance; otherwise, measurement result from serving cell is not included in a report instance. The field to indicate “with or without” measurement result from serving cell in a report instance can be configured by at least one of RRC, MAC CE, DCI, report configuration.

Alt-3: depend on whether serving cell is not in the best W cells or beam index corresponding to serving cell is not in best X beam indexes.

If serving cell is the best or strongest resource indicator, or the location of the best or strongest quality can be determined or indicated. Such as through a parameter with T bits, default method, e.g., at the forefront or first position, or last position.

Note that in a report instance, at least one of the location of the best or strongest cell or cell group, or the location of the best or strongest resource indicator, or the location of the best or strongest quality can be determined or indicated. Such as through a parameter with T bits, default method, e.g., at the forefront or first position, or last position.

### Embodiment 6

In the embodiment, we will introduce some criteria for reporting.

The detailed rule for reporting can consider at least one of the following:

Number of RSs to be reported: X;

Maximum number of RSs to be reported: Xmax;

Minimum number of RSs to be reported: Xmin;

Number of Cell/Cell group: Y;

Maximum number of Cell/Cell group: Ymax;

Minimum number of Cell/Cell group: Ymin;

Number of Cell/Cell group for one frequency: Y1;

Maximum number of Cell/Cell group for one frequency: Y1max;

Minimum number of Cell/Cell group for one frequency: Y1min;

Number of Cell/Cell group across different frequencies: Y2;

Maximum number of Cell/Cell group across different frequencies: Y2max;

Minimum number of Cell/Cell group across different frequencies: Y2min;

Number of RSs to be reported in a report instance: X1;

Maximum number of RSs to be reported in a report instance: X1max;

Minimum number of RSs to be reported in a report instance: X1min;

Number of RSs to be reported in a report instance for one frequency: X2;

Maximum number of RSs to be reported in a report instance for one frequency: X2max;

Minimum number of RSs to be reported in a report instance for one frequency: X2min;

Number of RSs to be reported in a report instance across different frequencies: X3;

Maximum number of RSs to be reported in a report instance across different frequencies: X3max;

Minimum number of RSs to be reported in a report instance across different frequencies: X3min;

Number of RSs to be reported in a report instance for a group of RS: X4;

Maximum number of RSs to be reported in a report instance for a group of RS: X4max;

Minimum number of RSs to be reported in a report instance for a group of RS: X4min;

Number of RSs to be reported per Cell/Cell group: X5;

Maximum number of RSs to be reported per Cell/Cell group: X5max;

Minimum number of RSs to be reported per Cell/Cell group: X5min;

Number of RSs to be reported different Cell/Cell group: X6;

Maximum number of RSs to be reported different Cell/Cell group: X6max;

Minimum number of RSs to be reported different Cell/Cell group: X6min;

Number of RSs to be reported in a report instance for one Cell/Cell group for one frequency: X7;

Maximum number of RSs to be reported in a report instance for one Cell/Cell group for one frequency: X7max;

Minimum number of RSs to be reported in a report instance for one Cell/Cell group for one frequency: X7min;

Number of RSs to be reported in a report instance for different Cells/Cell groups for one frequency: X8;

Maximum number of RSs to be reported in a report instance for different Cells/Cell groups for one frequency: X8max;

Minimum number of RSs to be reported in a report instance for different Cells/Cell groups for one frequency: X8min;

Number of RSs to be reported in a report instance for one Cell/Cell group across different frequencies: X9;

Maximum number of RSs to be reported in a report instance for one Cell/Cell group across different frequencies: X9max;

Minimum number of RSs to be reported in a report instance for one Cell/Cell group across different frequencies: X9min;

Number of RSs to be reported in a report instance for different Cells/Cell groups across different frequencies: X10;

Maximum number of RSs to be reported in a report instance for different Cells/Cell groups across different frequencies: X10max;

Minimum number of RSs to be reported in a report instance for different Cells/Cell groups across different frequencies: X10min;

Whether to report a specific Cell/Cell group in a report instance;

A group of RS is associated with same Cell/Cell group;

Different groups of RS are associated with different Cell/Cell group;

At least one of the above can be configured by at least one of RRC, MAC CE, DCI, pre-defined. In some examples, X, Xmax, Xmin, Y, Ymax, Ymin, Y1, Y1max, Y1min, Y2, Y2max, Y2min, X1, X1max, X1min, X2, X2max, X2min, X3, X3max, X3min, X4, X4max, X4min, X5, X5max, X5min, X6, X6max, X6min, X7, X7max, X7min, X8, X8max, X8min, X9, X9max, X9min, X10, X10max, X10min can be same or different value.

In some examples, a reporting config/triggering state is associated with K resource sets. K can be an integer value larger than or equal to 1.

### Embodiment 7

In the embodiment, we will introduce some methods on the configuration structure of at least one of measurement and measurement report and TCI state and RACH related information.

Taking the reporting as an example to illustrate the configuration method for measurement reporting. In some examples, measurement reporting information/configuration can be configured/included on/under at least one of: the first configuration; the second configuration, as shown in FIG. 12.

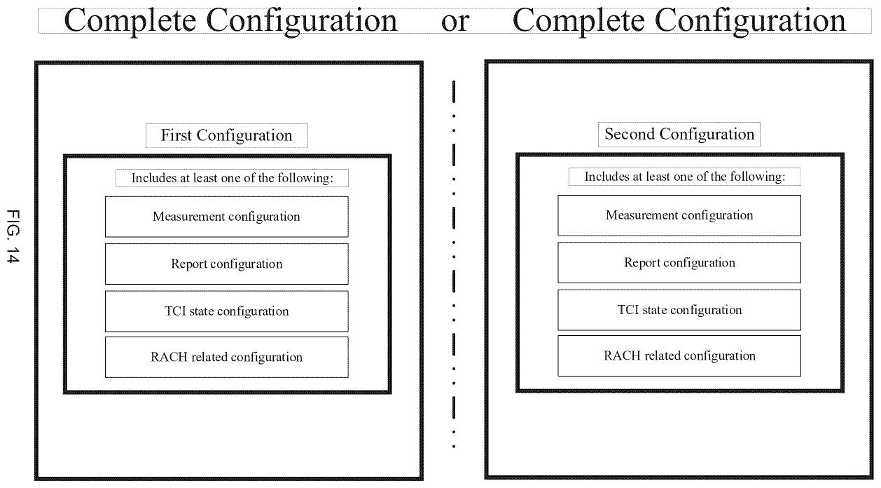

In some examples, complete reporting information/configuration consists of the information/configuration included/configured in the first configuration and the information/configuration included/configuration in the second configuration, as shown in FIG. 13.

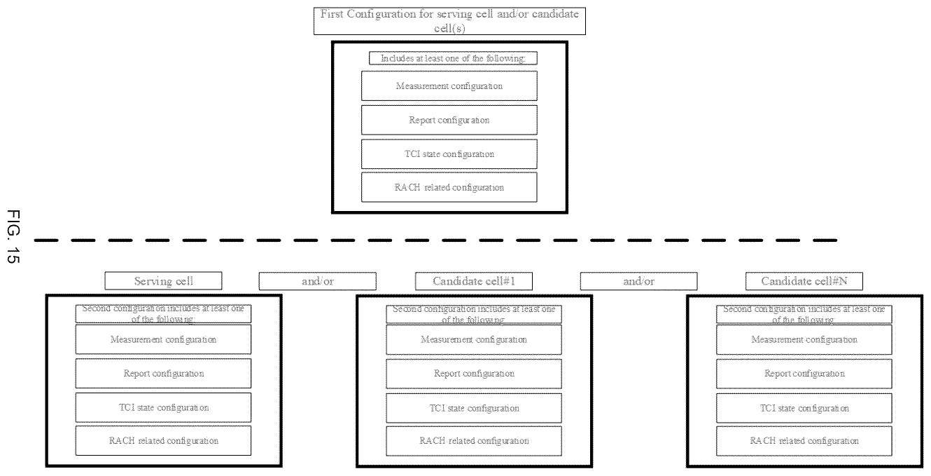

In some examples, at least one of the information/configurations included/configured in the first configuration and the information/configuration included/configuration in the second configuration is complete reporting information/configuration, as shown in FIG. 14.

In some examples, the first configuration is configured outside the serving cell and/or candidate cell. Optionally, the first configuration can be used for serving cells and/or candidate cell. The second configuration is configured for or under the serving cell and/or candidate cell, as shown in FIG. 15.

The same or similar configuration rule is applicable to measurement configuration, or TCI state configuration, or PRACH related configuration.

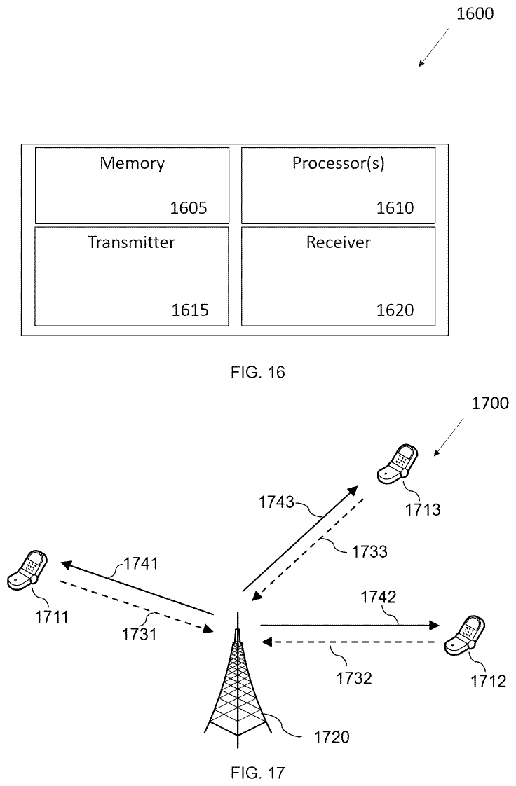

FIG. 16 shows an exemplary block diagram of a hardware platform 1600 that may be a part of a network device (e.g., base station) or a communication device (e.g., user equipment (UE)). The hardware platform 1600 includes at least one processor 1610 and a memory 1605 having instructions stored thereupon. The instructions upon execution by the processor 1610 configure the hardware platform 1600 to perform the operations described in FIG. 16 and in the various embodiments described in this patent application document. The transmitter 1615 transmits or sends information or data to another device. For example, a network device transmitter can send a message to user equipment. The receiver 1620 receives information or data transmitted or sent by another device. For example, user equipment can receive a message from a network device.

The implementations as discussed above will apply to a network communication. FIG. 17 shows an example of a communication system (e.g., a 6G or NR cellular network) that includes a base station 1720 and one or more user equipment (UE) 1711, 1712 and 1713. In some embodiments, the UEs access the BS (e.g., the network) using a communication link to the network (sometimes called uplink direction, as depicted by dashed arrows 1731, 1732, 1733), which then enables subsequent communication (e.g., shown in the direction from the network to the UEs, sometimes called downlink direction, shown by arrows 1741, 1742, 1743) from the BS to the UEs. In some embodiments, the BS send information to the UEs (sometimes called downlink direction, as depicted by arrows 1741, 1742, 1743), which then enables subsequent communication (e.g., shown in the direction from the UEs to the BS, sometimes called uplink direction, shown by dashed arrows 1731, 1732, 1733) from the UEs to the BS. The UE may be, for example, a smartphone, a tablet, a mobile computer, a machine to machine (M2M) device, an Internet of Things (IoT) device, and so on.

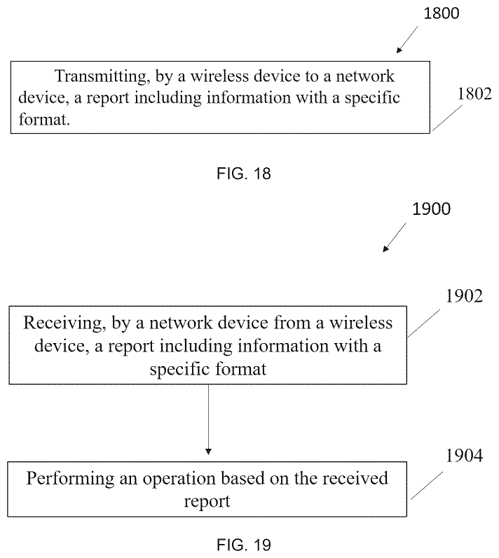

In one example aspect (e.g., as depicted in FIG. 18), a wireless communication method is disclosed. The method includes transmitting (1802), by a wireless device to a network device, a report including information with a specific format.

In another example aspect (e.g., as depicted in FIG. 19), another wireless communication method is disclosed. The method includes receiving (1902), by a network device from a wireless device, a report including information with a specific format; and performing (1904) an operation based on the received report.

In some embodiments, the information included in the report includes at least one of the following: a reference signal resource indicator (RSRI); identifications corresponding to a node, measurement quality corresponding to measured reference signal resource indicator; measurement quality index corresponding to measured reference signal resource indicator; or a report mode.

In some embodiments, the reference signal (RS) is at least one of the following: Synchronization Signal Block (SSB); or a Channel State Information Reference Signal (CSI-RS).

In some embodiments, the measurement quality is at least one of the following: Reference Signal Received Power (RSRP); Reference Signal Received Quality (RSRQ); or Signal to Interference Plus Noise Ratio (SINR).

In some embodiments, the report mode includes at least one of the following: a CSI based report; an event triggered report; or other report method.

In some embodiments, identification corresponding to a node is at least one of the following: Cell identification; Cell group identification; Cell index; Cell group index; Physical Cell identification; Physical Cell group identification; Logical Cell identification; Logical Cell group identification; Transmit/receive point (TRP) identification; Transmit/receive point (TRP) group identification; Physical TRP identification; Physical TRP group identification; Logical TRP identification; Logical TRP group identification; or Identification of other point rather than at least one of Cell and TRP and Cell group and TRP group.

In some embodiments, X different RSRI are included in a single report, where X is an integer larger than and/or equal to 0.

In some embodiments, W nodes are includes in a single report, where W is an integer larger than and/or equal to 0.

In some embodiments, X different RSRI is for each report setting or different report settings.

In some embodiments, Y nodes are configured for at least one of measurement and report, where Y is an integer larger than and/or equal to 0.

In some embodiments, relationship between X different RSRI and Y nodes is at least one of the following: X different RSRI are associated with or related to or corresponding to or selected from same node; X different RSRI are associated with or related to or corresponding to or selected from Y different node; X different RSRI are associated with or related to or corresponding to or selected from same resource set for a node; X different RSRI are associated with or related to or corresponding to or selected from different resource sets for a node; or X different RSRI are associated with or related to or corresponding to or selected from different resource sets for Y different nodes.

In some embodiments, relationship between X different RSRI and Y nodes can be one-to-one, or one-to-many, or many-to-one.

In some embodiments, the reported W nodes are determined or indicated by at least one of the following: a bitmap; or a node identification or index field.

In some embodiments, the bitmap consists of L bits.

In some embodiments, L is a fixed or variable or configurable value.

In some embodiments, L is determined by at least one of the following: Radio Resource Control (RRC); MAC Control Element (CE); Downlink Control Information (DCI); a default value; a pre-defined value; number of node; number of configured node; number of selected/updated/activated node; number of node except for best or strongest node; number of configured node except for best or strongest node; or number of elected/updated/activated node except for best or strongest node.

In some embodiments, L bits for the bitmap contains one of the following: M bits and Y-1 bits; or Y-1 bits and M bits.

In some embodiments, M bits are used to indicate a best or strongest node.

In some embodiments, Y-1 bits are used to indicate which one or multiple nodes except for best or strongest node to be reported.

In some embodiments, Y bits are used to indicate which one or multiple nodes to be reported.

In some embodiments, M bits location in bitmap or a structure of bitmap can be determined or indicated by at least one of the following: Radio Resource Control (RRC); A parameter in RRC; MAC Control Element (CE); Downlink Control Information (DCI); a default method; a pre-defined method,

In some embodiments, M bits is determined by at least one of the following: M=log2(ceil(node identification or index)); M=log2(ceil(the number of node identification or index));

In some embodiments, a node identification or index field is used to indicate a node corresponding to reported information.

In some embodiments, at least one of the following can be considered: for each node, X information are reported; for each node, X reported information consist of best or strongest information and differential information; for all nodes, X reported information consist of best or strongest information for best or strongest node and the differential information for node; information is reported based on information-based group for a node; information is reported based on information-based group for all nodes; X information are reported for all nodes in one frequency; X information are reported for all nodes across different frequencies; or X information are reported.

In some embodiments, the differential information is determined with a reference to the best or strongest information for a node.

In some embodiments, the differential information is determined with a reference to the best or strongest information for best or strongest node among all node.

In some embodiments, the information comprises at least one configuration configured or defined as: a number of measurement resource (X); a maximum number of measurement resource to report (Xmax); a minimum number of measurement resource to report (Xmin); a number of Cell/Cell group to be configured (Y); a number of Cell/Cell group to report (W); a maximum number of Cell/Cell group to be configured(Ymax); a maximum number of Cell/Cell group to report(Wmax); a minimum number of Cell/Cell group to be configured (Ymin); a minimum number of Cell/Cell group to report (Wmin); a number of Cell/Cell group for one frequency to be configured(Y1); a number of Cell/Cell group for one frequency to report (W1); a maximum number of Cell/Cell group for one frequency to be configured(Y1max); a maximum number of Cell/Cell group for one frequency to report(W1max); a minimum number of Cell/Cell group for one frequency to be configured(Y1min); a minimum number of Cell/Cell group for one frequency to report (W1min); a number of Cell/Cell group across different frequencies to be configured(Y2); a number of Cell/Cell group across different frequencies to report(W2); a maximum number of Cell/Cell group across different frequencies to be configured(Y2max); a maximum number of Cell/Cell group across different frequencies to report(W2max); a minimum number of Cell/Cell group across different frequencies to be configured(Y2min); or a minimum number of Cell/Cell group across different frequencies to report(Y2min).

In some embodiments, a report configuration that includes report information is associated with one or multiple measurement configuration; a report configuration is associated with one or multiple measurement configuration for one node; a report configuration is associated with one or multiple measurement configuration for different nodes; a report configuration is associated with one or multiple measurement configuration for different nodes in a frequency; a report configuration is associated with one or multiple measurement configuration for different nodes across different frequencies; a report configuration is associated with one or multiple measurement resources or measurement resource sets for one node; or a report configuration is associated with one or multiple measurement resources or measurement resource sets for different node.

In some embodiments, the node can be at least one of the following: Cell; TRP; Cell group; TRP group; Configured Cell; configured TRP; configured Cell group; configured TRP group; activated/updated/selected Cell; activated/updated/selected TRP; activated/updated/selected Cell group; activated/updated/selected TRP group; or other point except for at least one of Cell and Cell group and TRP and TRP group and configured activated/updated/selected Cell and Cell group and TRP and TRP group.

In some embodiments, at least one of report configuration and measurement configuration is determined depend on at least one of first reference configuration and second configuration.

Various preferred embodiments and additional features of the above-described method of FIGS. 18-19. Further examples are described with reference to embodiments 1 to 7.

The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or a variation of a subcombination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

What is claimed is:

1. A method for wireless communication, comprising:
transmitting, by a wireless device to a network device, a report including information with a specific format.

2. (canceled)

3. The method of claim 1, wherein the information included in the report includes at least one of the following:
X reference signal resource indicators (RSRIs), or Synchronization Signal Blocks (SSB) resource indicators (SSBRIs), or Channel State Information Reference Signal (CSI-RS) resource indicators (CRIs);
identifications corresponding to W nodes,
measurement quality corresponding to measured X RSRIs, SSBRIs or CRIs;
measurement quality index corresponding to measured X RSRIs, SSBRIs or CRIs; or
a report mode;
wherein X or W is an integer larger than or equal to 0.

4. The method of claim 3, wherein
the measurement quality is at least one of the following: Reference Signal Received Power (RSRP); Reference Signal Received Quality (RSRQ); or Signal to Interference Plus Noise Ratio (SINR); or
the report mode includes at least one of the following: a CSI based report; an event triggered report; or other report method; or
the identification corresponding to a node is at least one of the following: Cell identification; Cell group identification; Cell index; Cell group index; Physical Cell identification; Physical Cell group identification; Logical Cell identification; Logical Cell group identification; Transmit/receive point (TRP) identification; Transmit/receive point (TRP) group identification; Physical TRP identification; Physical TRP group identification; Logical TRP identification; Logical TRP group identification; or Identification of other point rather than at least one of Cell and TRP and Cell group and TRP group.

5. (canceled)

6. (canceled)

7. (canceled)

8. (canceled)

9. (canceled)

10. (canceled)

11. The method of claim 1, wherein Y nodes are configured for at least one of measurement and report, where Y is an integer larger than or equal to 0.

12. The method of claim 3, wherein relationship between X different RSRIs or SSBRIs or CRIs and Y or W nodes is at least one of the following:
X different RSRIs or SSBRIs or CRIs are associated with or related to or corresponding to or selected from same node;
X different RSRIs or SSBRIs or CRIs are associated with or related to or corresponding to or selected from Y or W different node;
X different RSRIs or SSBRIs or CRIs are associated with or related to or corresponding to or selected from same resource set for a node;
X different RSRIs or SSBRIs or CRIs are associated with or related to or corresponding to or selected from different resource sets for a node; or
X different RSRIs or SSBRIs or CRIs are associated with or related to or corresponding to or selected from different resource sets for Y or W different nodes.

13. The method of claim 12, wherein relationship between X different RSRI and Y nodes can be one-to-one, or one-to-many, or many-to-one.

14. The method of claim 3, wherein the reported W nodes are determined or indicated by at least one of the following:
a bitmap, wherein the bitmap consists of L bits; or
a node identification or index field.

15. (canceled)

16. The method of claim 14, wherein
L is a fixed or variable or configurable value; or
L is determined by at least one of the following: Radio Resource Control (RRC); MAC Control Element (CE); Downlink Control Information (DCI); a default value; a pre-defined value; number of node; number of configured node; number of selected/updated/activated node; number of node except for best or strongest node; number of configured node except for best or strongest node; or number of elected/updated/activated node except for best or strongest node.

17. (canceled)

18. The method of claim 3, wherein L bits for the bitmap contains one of the following:
M bits and Y-1 bits; or
Y-1 bits and M bits.

19. The method of claim 16, wherein
M bits are used to indicate a best or strongest node; or
Y-1 bits are used to indicate which one or multiple nodes except for best or strongest node to be reported; or
Y bits are used to indicate which one or multiple nodes to be reported.

20. (canceled)

21. (canceled)

22. The method of claim 18, wherein
M bits location in bitmap or a structure of bitmap can be determined or indicated by at least one of the following:
Radio Resource Control (RRC);
A parameter in RRC;
MAC Control Element (CE);
Downlink Control Information (DCI);
a default method;
a pre-defined method; or
M bits is determined by at least one of the following: M=1og2(ceil(node identification or index)); M=log2(ceil(the number of node identification or index)).

23. (canceled)

24. The method of claim 14, wherein a node identification or index field is used to indicate a node corresponding to reported information.

25. The method of claim 1, wherein at least one of the following can be considered:
for each node, X information are reported;
for each node, X reported information consist of best or strongest information and differential information;
for all nodes, X reported information consist of best or strongest information for best or strongest node and the differential information for node;
information is reported based on information-based group for a node;
information is reported based on information-based group for all nodes;
X information are reported for all nodes in one frequency;
X information are reported for all nodes across different frequencies; or
X information are reported.

26. The method of claim 25, wherein
the differential information is determined with a reference to the best or strongest information for a node.

27. The method of claim 25, wherein the differential information is determined with a reference to the best or strongest information for best or strongest node among all node.

28. The method of claim 1, wherein the information comprises at least one configuration configured or defined as:
a number of measurement resource (X);
a maximum number of measurement resource to report (Xmax);
a minimum number of measurement resource to report (Xmin);
a number of Cell/Cell group to be configured (Y);
a number of Cell/Cell group to report (W);
a maximum number of Cell/Cell group to be configured(Ymax);
a maximum number of Cell/Cell group to report(Wmax);
a minimum number of Cell/Cell group to be configured (Ymin);
a minimum number of Cell/Cell group to report (Wmin);
a number of Cell/Cell group for one frequency to be configured(Y1);
a number of Cell/Cell group for one frequency to report (W1);
a maximum number of Cell/Cell group for one frequency to be configured(Y1max);
a maximum number of Cell/Cell group for one frequency to report(W1max);
a minimum number of Cell/Cell group for one frequency to be configured(Y1min);
a minimum number of Cell/Cell group for one frequency to report (W1min);
a number of Cell/Cell group across different frequencies to be configured(Y2);
a number of Cell/Cell group across different frequencies to report(W2);
a maximum number of Cell/Cell group across different frequencies to be configured(Y2max);
a maximum number of Cell/Cell group across different frequencies to report(W2max);
a minimum number of Cell/Cell group across different frequencies to be configured(Y2min); or
a minimum number of Cell/Cell group across different frequencies to report(Y2min).

29. The method of claim 1, wherein a report configuration that includes report information is associated with one or multiple measurement configuration; a report configuration is associated with one or multiple measurement configuration for one node; a report configuration is associated with one or multiple measurement configuration for different nodes; a report configuration is associated with one or multiple measurement configuration for different nodes in a frequency; a report configuration is associated with one or multiple measurement configuration for different nodes across different frequencies; a report configuration is associated with one or multiple measurement resources or measurement resource sets for one node; or a report configuration is associated with one or multiple measurement resources or measurement resource sets for different node.

30. The method of claim 3, wherein the node can be at least one of the following: Cell; TRP; Cell group; TRP group; Configured Cell; configured TRP; configured Cell group; configured TRP group; activated/updated/selected Cell; activated/updated/selected TRP; activated/updated/selected Cell group; activated/updated/selected TRP group; or other point except for at least one of Cell and Cell group and TRP and TRP group and configured activated/updated/selected Cell and Cell group and TRP and TRP group.

31. The method of claim 1, wherein at least one of report configuration and measurement configuration is determined depend on at least one of first reference configuration and second configuration.

32. (canceled)

33. (canceled)

34. A method for wireless communication, comprising:
receiving, by a network device from a wireless device, a report including information with a specific format; and
performing an operation based on the received report.
